(19) United States
(12) Patent Application Publication
(10) Pub. No.: US 2024/0410995 A1
(43) Pub. Date: Dec. 12, 2024

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventors: KAZUMA SAKATO, Kanagawa (JP); YOHEI HORIKAWA, Tokyo (JP)

(21) Appl. No.: 18/680,172

(22) Filed: May 31, 2024

(30) Foreign Application Priority Data
Jun. 12, 2023 (JP) 2023-096150

(51) Int. Cl. G01S 7/486; G01S 7/4915; G01S 17/10

(52) U.S. Cl. CPC G01S 7/4868; G01S 7/4915; G01S 17/10

(57) ABSTRACT

A control apparatus is configured to control a first optical system for acquiring image information and a second optical system different from the first optical system. The control apparatus includes a memory storing instructions, and a processor that executes the instructions to acquire at least one of first distance information corresponding to the image information and obtained by using the first optical system, and second distance information corresponding to the image information and obtained by using the second optical system, and control the first optical system to acquire the first distance information in a case where reliability of the first distance information is higher than a predetermined value, and control the second optical system to acquire the second distance information in a case where the reliability is lower than the predetermined value.

### BACKGROUND

### Technical Field

One of the aspects of the embodiments relates to a control apparatus, an image pickup apparatus, a control method, and a storage medium.

### Description of Related Art

The passive distance measuring method of measuring a distance using image information and the active distance measuring method of measuring a distance by emitting auxiliary light have conventionally been known as methods of measuring a distance to a target. The passive distance measuring method has difficulty in highly accurately acquiring a distance to a distant target. One known example of the active distance measuring method is Light Detection And Ranging (LiDAR) that measures a distance to a target based on a period from when an infrared laser beam is irradiated onto a target to when reflected light is received from the target. LiDAR can highly accurately acquire distance information irrespective of a distance to a target, but consumes electric power larger than that of the passive distance measuring method. Each distance measuring method has advantages and disadvantages. PCT International Publication WO 2015/083539 discloses a configuration of selecting any of the active distance measuring method and the passive distance measuring method based on average luminance of a captured image.

The configuration disclosed in PCT International Publication WO 2015/083539 does not switch from the passive distance measuring method to the active distance measuring method in acquiring a distance to a low-contrast target or in acquiring a distance to a target in a blurred state that is an out-of-focus state over the entire screen, and thus its distance measuring accuracy degrades.

### SUMMARY

A control apparatus according to one aspect of the disclosure is configured to control a first optical system for acquiring image information and a second optical system different from the first optical system. The control apparatus includes a memory storing instructions, and a processor that executes the instructions to acquire at least one of first distance information corresponding to the image information and obtained by using the first optical system, and second distance information corresponding to the image information and obtained by using the second optical system, and control the first optical system to acquire the first distance information in a case where reliability of the first distance information is higher than a predetermined value, and control the second optical system to acquire the second distance information in a case where the reliability is lower than the predetermined value. An image pickup apparatus having the above control apparatus, a control method corresponding to the above control apparatus, and a storage medium storing a program that causes a computer to execute the above control method also constitute another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of the configuration of an image pickup apparatus according to a first embodiment.

FIGS. 2A, 2B, and 2C explain an image sensor according to the first embodiment.

FIG. 3 is a sectional view illustrating an imaging relationship of an optical image on the image sensor according to the first embodiment.

FIGS. 4A and 4B explain a LiDAR distance measuring unit according to the first embodiment.

FIG. 5 is a flowchart illustrating an operation of the image pickup apparatus according to the first embodiment.

FIG. 6 is a flowchart illustrating second distance information acquiring processing according to the first embodiment.

FIG. 7 is a timing chart illustrating the timing of acquisition of distance information according to a second embodiment.

FIG. 8 is a block diagram of the configuration of an image pickup apparatus according to a third embodiment.

FIG. 9 is a flowchart illustrating the second distance information acquiring processing according to the third embodiment.

FIG. 10 is a block diagram of the configuration of an image pickup apparatus according to a fourth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

The passive distance measuring method of measuring a distance using image information and an active distance measuring method of measuring a distance by emitting auxiliary light have conventionally been known as methods of measuring distance to a target.

The phase difference detecting method as the passive distance measuring method arranges phase difference detection pixels that detect signals with different phases on an image sensor and acquires distance information on an object by calculating correlation between the signals with the different phases.

The active distance measuring method measures a distance to a target (object) based on a time difference (round-trip time of an infrared laser beam) between the timing of light emission from an infrared laser and the timing of detection of reflected light from the target. For example, a sensor that detects the reflected light can use a single photon avalanche diode (SPAD) sensor capable of detecting a single photon. The SPAD sensor detects an incident single photon as a detection pulse of an extremely short time through avalanche multiplication. In practically used technologies, the time between the timing of light emission from the infrared laser and the timing of the detection pulse is measured by a time-to-digital converter (TDC). In reality, since fluctuation is large with an arrival time point of one photon, infrared laser light emission and single-photon detection are periodically repeated, and time measurement results are plotted into a histogram and statistically processed. Thereby, the accuracy of time difference measurement, in other words, distance measurement (hereinafter referred to as LiDAR distance measurement) can be improved. Moreover, infrared lasers and SPAD sensors can be two-dimensionally arrayed to two-dimensionally plot results of the LiDAR distance measurement so that what is called a distance map can be generated. Recent image capturing devices can achieve generation of a stereoscopic computer graphics model and a planar map (these will be collectively referred to as a space model or a D model hereinafter) and autofocus (AF) by using a distance map and a captured image.

### First Embodiment

This embodiment will discuss an example that determines the reliability of distance information obtained by the passive distance measuring method and switches the passive distance measuring method to the active distance measuring method in a case where the reliability is low. More specifically, in a case where the reliability of distance information acquired by using a first optical system is low, distance information is acquired by using a second optical system.

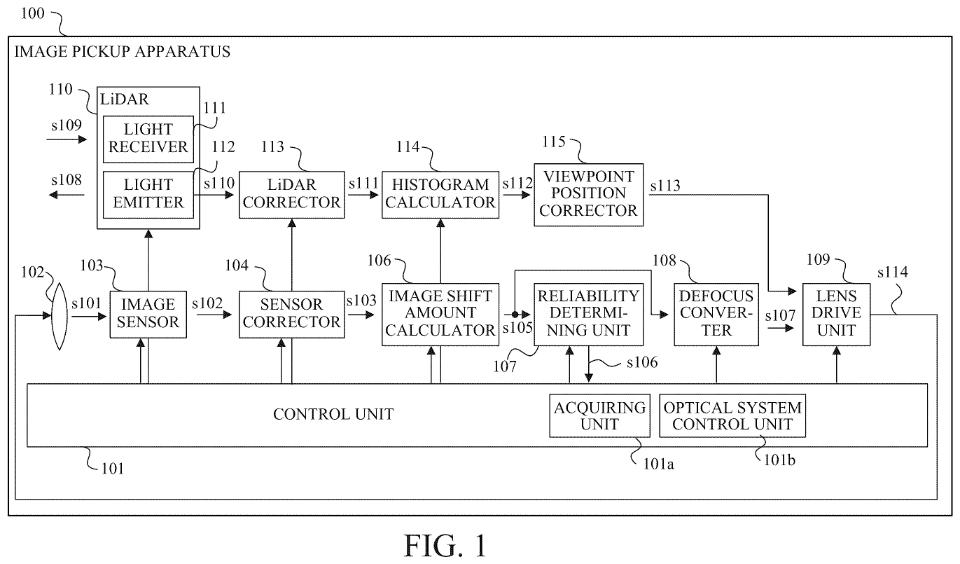

FIG. 1 is a block diagram of the configuration of an image pickup apparatus 100 according to this embodiment. The image pickup apparatus 100 is, for example, a digital camera, a smartphone, or a drone. The image pickup apparatus 100 includes a control unit 101, an imaging lens 102, an image sensor (imaging unit) 103, a sensor corrector 104, an image shift amount calculator 106, a reliability determining unit 107, a defocus converter 108, and a lens drive unit 109. The image pickup apparatus 100 further includes a LiDAR distance measuring unit 110, a LiDAR corrector 113, a histogram calculator 114, and a viewpoint position corrector 115. The imaging lens 102, the image sensor 103, and the image shift amount calculator 106 function as a first optical system and acquire image information and first distance information corresponding to the image information. The LiDAR distance measuring unit 110 functions as a second optical system and acquires second distance information corresponding to the image information acquired by using the first optical system.

Reference numeral s101 denotes incident light relating to imaging, reference numeral s102 denotes visible light raw data, reference numeral s103 denotes various corrected image signals, reference numeral s105 denotes an image shift amount, reference numeral s106 denotes a reliability determination result, and reference numeral s107 denotes a defocus amount. Reference numeral s108 denotes a laser beam, reference numeral s109 denotes reflected light from a target irradiated with the laser beam s108, reference numeral s110 denotes LiDAR distance measurement information, reference numeral s111 denotes various kinds of corrected distance information, reference numeral s112 denotes a distance map, and reference numeral s113 denotes distance information with a corrected viewpoint position. Reference numeral s114 denotes a lens drive amount.

The control unit 101 is a control apparatus configured to control the entire image pickup apparatus 100. The control unit 101 receives the reliability determination result s106 from the reliability determining unit 107 and controls the LiDAR distance measuring unit 110. The control unit 101 executes calculation processing and control processing in accordance with various computer programs stored in an unillustrated memory.

The control unit 101 includes an acquiring unit 101a and an optical system control unit 101b. The acquiring unit 101a acquires at least one of the first distance information and the second distance information. The first distance information corresponds to the image information and is obtained by using the first optical system. The second distance information corresponds to the image information and is obtained by using the second optical system. The optical system control unit 101b controls the first optical system so that the acquiring unit 101a acquires the first distance information in a case where the reliability of the first distance information is higher than a predetermined value. The optical system control unit 101b controls the second optical system so that the acquiring unit 101a acquires the second distance information in a case where the reliability of the first distance information is lower than the predetermined value. An optical system to be control can be arbitrarily set in a case where the reliability of the first distance information is equal to the predetermined value.

In other words, in this embodiment, at least one processor functions as the acquiring unit 101a and the optical system control unit 101b when executing a computer program stored in at least one memory. More specifically, at least one processor executes processing of acquiring at least one of the first distance information and the second distance information and processing of controlling any of the first and second optical systems in accordance with a duration in which one of the first distance information and the second distance information cannot be acquired.

The imaging lens 102 condenses the incident light s101 onto the image sensor 103. The imaging lens 102 performs AF control by moving based on the lens drive amount s114 from the lens drive unit 109. The first optical system including the imaging lens 102 and the image sensor 103 shares at least part of an angle of view with the second optical system including the LiDAR distance measuring unit 110. More specifically, the first and second optical systems capture at least one same target.

The image sensor 103 includes a plurality of pixels each including a micro lens and a photoelectric converter and generates the visible light RAW data s102 by photoelectrically converting an image formed through the imaging lens 102.

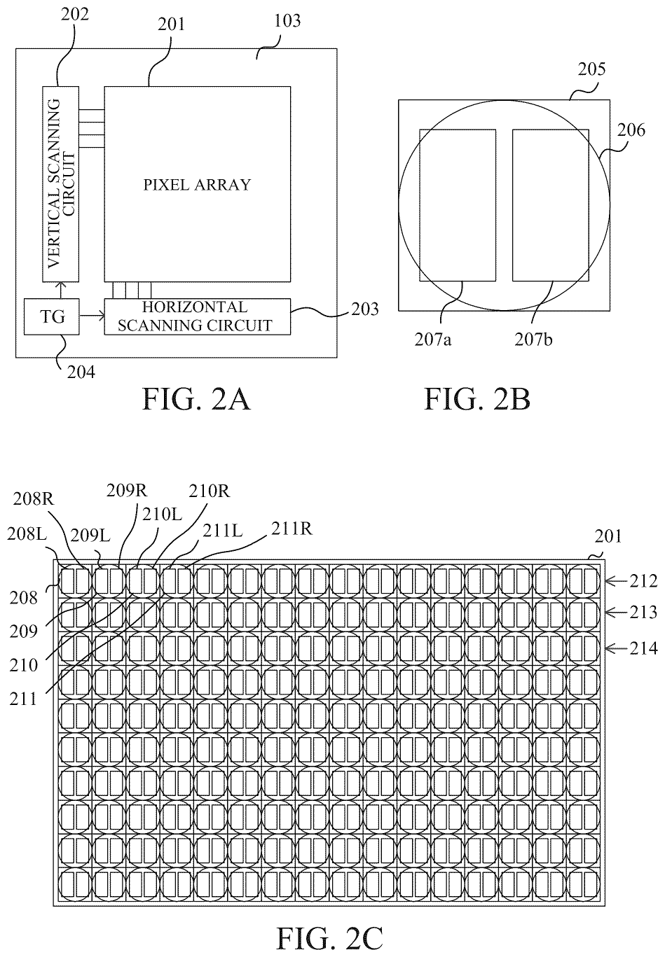

FIGS. 2A, 2B, and 2C explain the image sensor 103 according to this embodiment. FIG. 2A illustrates the configuration of the image sensor 103. The image sensor 103 includes a pixel array 201, a vertical scanning circuit 202, a horizontal scanning circuit 203, and a timing generator TG204. The pixel array 201 includes a plurality of unit pixel cells arrayed in a two-dimensional matrix of rows and columns. The timing generator TG204 generates timing of an imaging duration, a forwarding duration, or the like and transfers a timing signal to the vertical scanning circuit 202 and the horizontal scanning circuit 203. At timing when the imaging duration ends, the vertical scanning circuit 202 transmits, to a vertical transmission path, signals output from the unit pixel cells. The horizontal scanning circuit 203 sequentially outputs accumulated signals to the outside through an output transmission path.

FIG. 2B illustrates one unit pixel cell 205 in the pixel array 201. The unit pixel cell 205 includes one micro lens 206 and a pair of photoelectric converters 207a and 207b. The photoelectric converters 207a and 207b perform pupil division by receiving light beams having passed through the common micro lens 206 and pupil regions different from each other at an exit pupil of the imaging lens 102. FIG. 2C illustrates the pixel array 201. In the image sensor 103, the plurality of unit pixel cells are two-dimensionally arrayed in the row and column directions in the pixel array 201 to provide a two-dimensional image signal. Unit pixel cells 208, 209, 210, and 211 correspond to the unit pixel cell 205 in FIG. 2B. Photoelectric converters 208L, 209L, 210L, and 211L correspond to the photoelectric converter 207a in FIG. 2B. Photoelectric converters 208R, 209R, 210R, and 211R correspond to the photoelectric converter 207b in FIG. 2B.

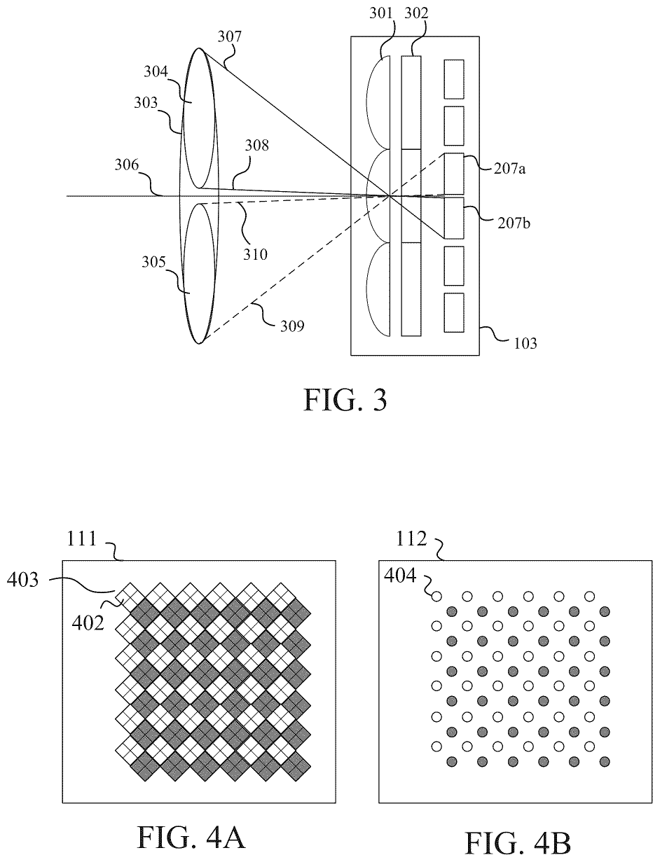

Referring now to FIG. 3, a description will be given of an imaging relationship of an optical image (object image) on the image sensor 103. FIG. 3 is a sectional view illustrating the imaging relationship of an optical image on the image sensor 103 and conceptually illustrates a situation in which light beams emitted from the exit pupil of the imaging lens 102 enter the image sensor 103. Reference number 301 denotes a micro lens, and reference number 302 denotes a color filter. Reference number 303 denotes the exit pupil of the imaging lens 102.

Light beams emitted from the exit pupil 303 enter the image sensor 103 with a center at an optical axis 306. Reference numbers 304 and 305 denote partial regions of the exit pupil 303. Reference numbers 307 and 308 denote outermost rays of light passing through the partial region 304 of the exit pupil 303, and reference numerals 309 and 310 denote outermost rays of light passing through the partial region 305 of the exit pupil 303.

As illustrated in FIG. 3, among light beams emitted from the exit pupil 303, a light beam above the optical axis 306 enter the photoelectric converter 207b, and a light beams below the optical axis 306 enter the photoelectric converter 207a. That is, the photoelectric converters 207a and 207b receive light through different regions, respectively, of the exit pupil 303. A phase difference is detected by utilizing such a characteristic.

Referring now to FIG. 2C, a description will be given of the phase difference detecting method. The photoelectric converter 207a in the unit pixel cell 205 is used as an A-image pixel group that photoelectrically converts an A-image among a pair of object images for focus detection by the phase difference detecting method. The photoelectric converter 207b is used as a B-image pixel group that photoelectrically converts a B-image among the pair of object images.

In the pixel array 201 in FIG. 2C, the A-image pixel group is a row 212 on which the photoelectric converters 208L to 211L . . . are referred, and the B-image pixel group is a row 213 on which the photoelectric converters 208R to 211R . . . are referred. A phase difference signal can be acquired by calculating correlation between a signal obtained from the A-image pixel group and a signal obtained from the B-image pixel group. Rows such as the rows 212 and 213 from which phase difference signals are output to the image shift amount calculator 106 will be referred to as phase difference detecting pixel rows. AF that performs focus detection of the phase difference detecting method in this manner by using the A-image pixel group and the B-image pixel group provided in the image sensor 103 will be referred to as imaging-surface phase-difference AF. On a row 214, an image signal can be read by adding signals from the two photoelectric converters of each unit pixel cell. A row such as the row 214 from which an image signal is output to the sensor corrector 104 will be referred to as a normal pixel row. Each unit pixel cell on the normal pixel row may include only one photoelectric converter instead of two divided photoelectric converters.

Any method other than the method described above in this embodiment may be used as the phase difference detecting method. For example, a light-shielding unit and focus detecting pixels may be disposed below a micro lens where pupil division is performed, and outputs from two kinds of focus detecting pixels corresponding to different opening positions of the light-shielding unit may be combined to form a pair of image signals of an object image.

The sensor corrector 104 performs various kinds of correction processing such as shading correction and black level correction for a signal output from the image sensor 103.

The image shift amount calculator 106 acquires information (first distance information) relating to an object distance by calculating correlation among image signals of light beams received in different incident directions. In other words, the image shift amount calculator 106 functions as a distance measuring unit configured to acquire the first distance information based on outputs from phase difference detecting pixels. The image shift amount calculator 106 calculates the image shift amount s105 based on a correlation calculation result.

The reliability determining unit 107 determines the reliability of the image shift amount s105 output from the image shift amount calculator 106, thereby determining the reliability of the first distance information acquired by the image shift amount calculator 106. The reliability determining unit 107 outputs the reliability determination result s106 to the control unit 101. In this embodiment, the reliability determining unit 107 determines the reliability of the image shift amount s105 using the contrast value of a captured image. More specifically, the reliability determining unit 107 determines that the reliability of the image shift amount s105 is higher than a predetermined value in a case where the contrast value of the captured image is higher than a predetermined contrast value, and the reliability determining unit 107 determines that the reliability of the image shift amount s105 is lower than the predetermined value in a case where the contrast value of the captured image is lower than the predetermined contrast value.

The defocus converter 108 calculates the defocus amount s107 by multiplying the image shift amount s105 output from the image shift amount calculator 106 by a predetermined conversion coefficient.

The lens drive unit 109 calculates the lens drive amount s114 by which the imaging lens 102 is to be moved by using the defocus amount s107 from the defocus converter 108 or the distance information s113 from the viewpoint position corrector 115.

The LiDAR distance measuring unit 110 includes a laser light emitter 112 and a laser light receiver 111.

Referring now to FIGS. 4A and 4B, a description will be given of the LiDAR distance measuring unit 110. FIGS. 4A and 4B explain the LiDAR distance measuring unit 110. FIG. 4A illustrates the laser light receiver 111, and FIG. 4B illustrates the laser light emitter 112.

The laser light emitter 112 includes a plurality of laser light-emitting elements 404 two-dimensionally arranged in a horizontal direction and a vertical direction and emits an infrared laser beam to the outside in accordance with a laser pulse control signal from the control unit 101.

The laser light receiver 111 includes a plurality of two-dimensionally arranged SPAD elements 402 corresponding to the laser light-emitting elements 404, respectively, and generates the LiDAR distance measurement information s110 by receiving reflected light of an infrared laser beam that has been emitted from the laser light emitter 112 and irradiated onto a target. Ideally, distance information can be acquired by disposing one SPAD element 402 for one laser light-emitting element 404, but in reality, reflected light shifts from an intended point in some cases. Therefore, in this embodiment, a SPAD element group 403 as a collection of four SPAD elements 402 functions as one SPAD element for one laser light-emitting elements 404. Highly accurate distance information can be acquired by averaging output results from the four SPAD elements 402.

The LiDAR corrector 113 performs, for the LiDAR distance measurement information s110, various kinds of correction processing such as correction of positional shift between the laser light receiver 111 and the laser light emitter 112 and correction relating to a temperature characteristic. The LiDAR corrector 113 outputs the distance information s111 obtained by correcting the LiDAR distance measurement information s110 to the histogram calculator 114.

The histogram calculator 114 improves distance measuring accuracy by applying histogram processing to the distance information s111 and outputs the processed distance information s111 as the distance map s112 of two dimensions with the same number of elements as the laser light emitter 112.

The viewpoint position corrector 115 generates the distance information s113 by correcting a viewpoint position shift between the LiDAR distance measuring unit 110 and the imaging lens 102 for the distance map s112.

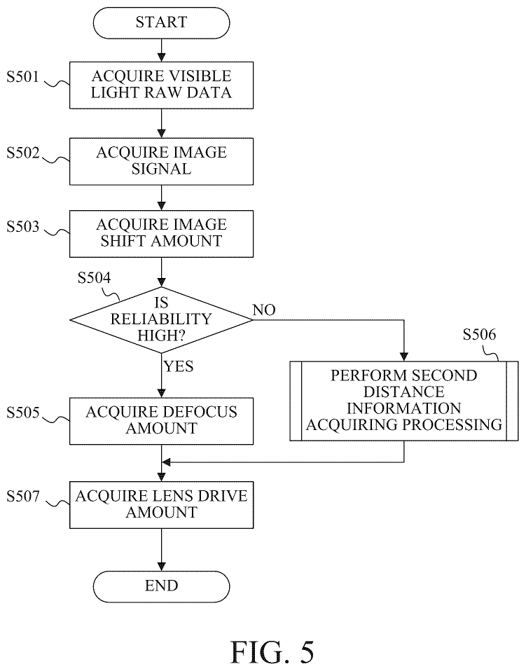

Referring now to FIG. 5, a description will be given of an operation of the image pickup apparatus 100 according to this embodiment. FIG. 5 is a flowchart illustrating the operation of the image pickup apparatus 100 according to this embodiment. Processing of the flowchart in FIG. 5 is started when a shutter button included in an unillustrated operation unit is pressed by a user.

At step S501, the control unit 101 acquires the visible light RAW data s102 by driving the image sensor 103.

At step S502, the control unit 101 acquires the image signal s103 by driving the sensor corrector 104 to perform various kinds of correction processing.

At step S503, the control unit 101 acquires the image shift amount s105 by driving the image shift amount calculator 106.

At step S504, the control unit 101 acquires a determination result indicating whether the reliability of the image shift amount s105 is high by driving the reliability determining unit 107. In this embodiment, the reliability determining unit 107 determines that the reliability of the image shift amount s105 is higher than a predetermined value in a case where the contrast value of a captured image is higher than a predetermined contrast value, and the reliability determining unit 107 determines that the reliability of the image shift amount s105 is lower than the predetermined value in a case where the contrast value of the captured image is lower than the predetermined contrast value. Whether to determine the reliability of the image shift amount s105 is high or low may be arbitrarily set in a case where the contrast value of the captured image is equal to the predetermined contrast value. The control unit 101 executes processing at step S505 in a case where the reliability of the image shift amount s105 is higher than the predetermined value, and executes processing at step S506 in a case where the reliability of the image shift amount s105 is lower than the predetermined value.

At step S505, the control unit 101 acquires the defocus amount s107 by driving the defocus converter 108 to perform defocus conversion for the image shift amount s105.

At step S506, the control unit 101 acquires distance information (the second distance information) by controlling the second optical system since the reliability of distance information (the first distance information) acquired by controlling the first optical system is low. More specifically, the control unit 101 executes processing (second distance information acquiring processing) of acquiring the second distance information by driving the LiDAR distance measuring unit 110.

At step S507, the control unit 101 acquires, by driving the lens drive unit 109, the lens drive amount s114 based on the defocus amount s107 acquired at step S505 or the distance information s113 acquired at step S506.

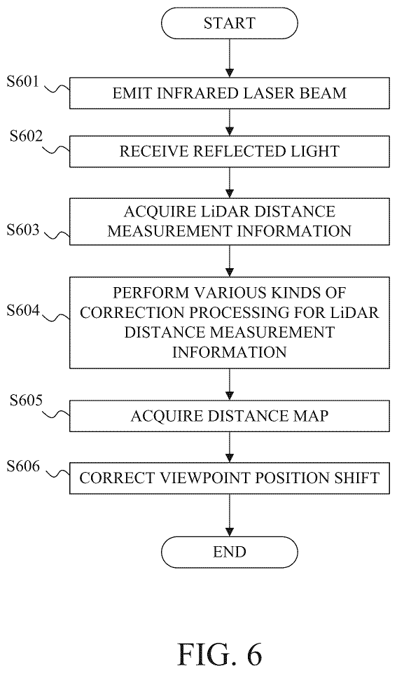

Referring now to FIG. 6, a description will be given of the second distance information acquiring processing at step S507 in FIG. 5. FIG. 6 is a flowchart illustrating the second distance information acquiring processing.

At step S601, the control unit 101 emits an infrared laser beam to the outside at a particular interval by driving the laser light emitter 112.

At step S602, the control unit 101 receives, by driving the laser light receiver 111, reflected light from a target irradiated with the infrared laser beam at step S601.

At step S603, the control unit 101 acquires the LiDAR distance measurement information s110 by extracting time-of-flight (TOF) information on the infrared laser beam emitted at the particular interval and then reflected by the target.

At step S604, the control unit 101 performs various kinds of correction processing for the LiDAR distance measurement information s110 by driving the LiDAR corrector 113, thereby acquiring the corrected distance information s111.

At step S605, the control unit 101 acquires the distance map s112 by driving the histogram calculator 114 to apply histogram processing to the distance information s111 and improve the distance measuring accuracy.

At step S606, the control unit 101 corrects a viewpoint position shift between the LiDAR distance measuring unit 110 and the imaging lens 102 by driving the viewpoint position corrector 115, thereby acquiring the distance information s113.

As described above, the configuration according to this embodiment can highly accurately acquire distance information by driving the LiDAR distance measuring unit 110 in a case where the reliability of distance information acquired by using the first optical system is low. The configuration according to this embodiment can also reduce electric power consumption in comparison with a case where the LiDAR distance measuring unit 110 is constantly driven.

In this embodiment, the reliability determining unit 107 determines the reliability of the image shift amount s105 using the contrast value of a captured image, but this embodiment is not limited to this example. For example, the reliability determining unit 107 may determine the reliability of the image shift amount s105 based on whether the first optical system is in a blurred state that is an out-of-focus state. The phase difference detecting method cannot correctly acquire distance information in a case where the first optical system is in the blurred state. On the other hand, LiDAR uses the second optical system different from the first optical system, and can highly accurately acquire distance information without being affected by whether the first optical system is in the blurred state. Whether the first optical system is in the blurred state may be determined based on whether the focus position of the first optical system is outside a predetermined range. More specifically, it may be determined that the first optical system is not in the blurred state in a case where the focus position of the first optical system is in the predetermined range, and that the first optical system is in the blurred state in a case where the focus position of the first optical system is outside the predetermined range.

### Second Embodiment

This embodiment will discuss an example that acquires distance information using the second optical system while the first optical system acquires image information (still image) for recording. The configuration of the image pickup apparatus 100 according to this embodiment is the same as that of the image pickup apparatus 100 according to the first embodiment, and this embodiment will discuss only a configuration different from that of the first embodiment and will omit a description of a common configuration.

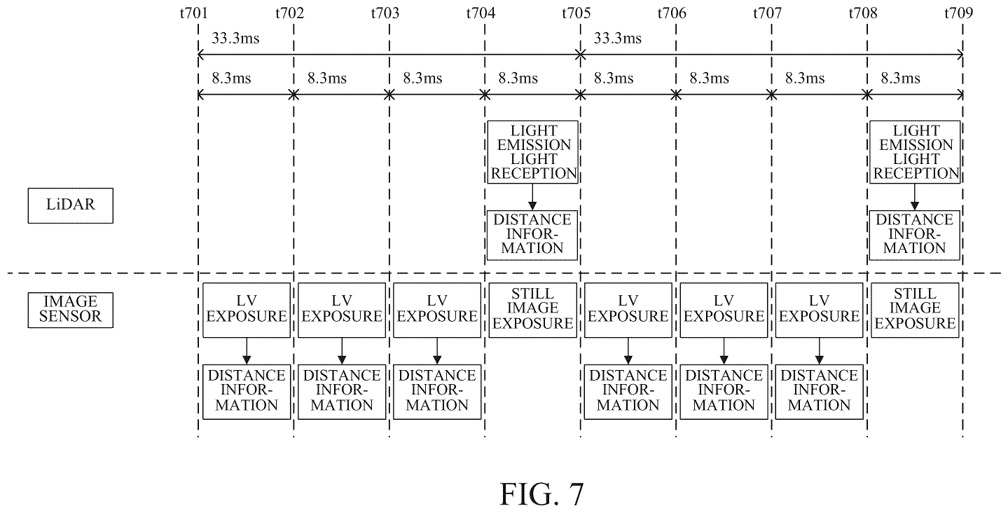

Referring now to FIG. 7, a description will be given of an operation of the image pickup apparatus 100 according to this embodiment. FIG. 7 is a timing chart illustrating the timing of acquiring distance information according to this embodiment. This embodiment will discuss an example in which a live-view image is acquired at 120 fps (frame per sec) and a still image for recording is acquired at 30 fps. A live-view image is an image displayed on an unillustrated electronic viewfinder (EVF) before actual imaging is performed.

A normal digital camera uses a live-view image to acquire distance information to be used for AF because the number of necessary pixels is not large in comparison with a still image. That is, distance information is not acquired in a frame in which still image exposure is performed, and thus continuous distance information may not be acquired. In such a case, for example, in an attempt to use distance information to predict a moving object to follow the object, a defect frame may occur and the prediction accuracy of the moving object may degrade.

Accordingly, this embodiment drives the LiDAR distance measuring unit 110 included in the second optical system and acquires distance information while the first optical system acquires a still image. Thereby, distance information can be continuously acquired during still image exposure as well, and the prediction accuracy of the moving object can be improved.

The frame rate of acquiring distance information using the second optical system may be lower than the frame rate of acquiring distance information using the first optical system. Since distance information is acquired at 120 fps by using the first optical system and distance information is acquired at 30 fps by using the second optical system as described above in this embodiment, electric power consumption can be reduced in comparison with a case where a plurality of optical systems are constantly driven at the same frame rate.

### Third Embodiment

This embodiment will discuss an example that detects a remaining battery level and does not perform the LiDAR distance measurement in a case where the detected remaining battery level is smaller than a predetermined level. For smartphones and digital cameras, it is one of particularly important matters to suppress battery consumption. This embodiment will discuss only a configuration different from that of the first and second embodiments, and will omit a description of a common configuration.

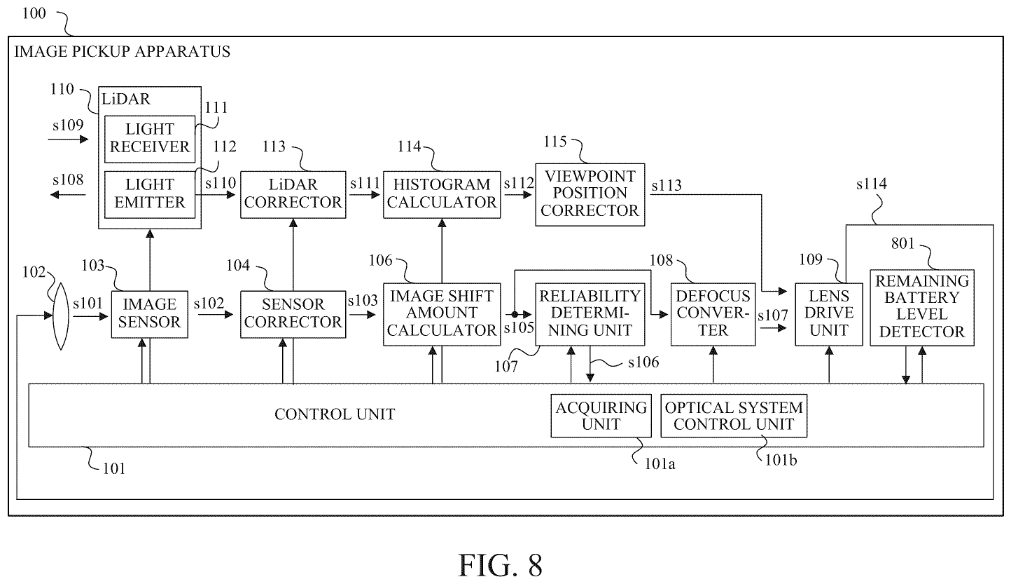

FIG. 8 is a block diagram of the configuration of the image pickup apparatus 100 according to this embodiment. The configuration of the image pickup apparatus 100 according to this embodiment is basically the same as the configuration of the image pickup apparatus 100 according to the first embodiment. The image pickup apparatus 100 according to this embodiment includes a remaining battery level detector 801 unlike the image pickup apparatus 100 according to the first embodiment. The remaining battery level detector 801 detects the remaining level an unillustrated battery that supplies electric power of the entire image pickup apparatus 100. Different batteries may be used for the first and second optical systems.

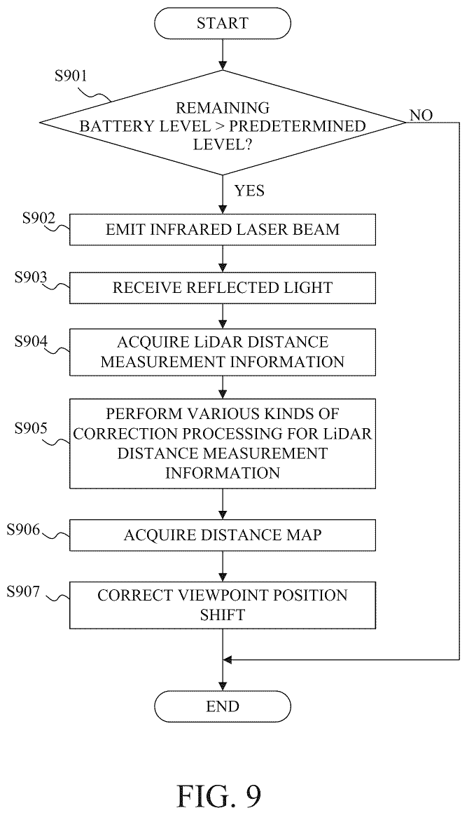

FIG. 9 is a flowchart illustrating the second distance information acquiring processing according to this embodiment.

At step S901, the control unit 101 acquires the battery remaining amount by driving the remaining battery level detector 801 and determines whether the remaining battery level is larger than a predetermined level. In a case where the control unit 101 determines that the remaining battery level is larger than the predetermined level, the control unit 101 executes processing at step S902. Processing steps S902 to S907 is the same as the processing steps S601 to S606 in FIG. 6, respectively, and thus a description thereof will be omitted. In a case where the control unit 101 determines that the remaining battery level is smaller than the predetermined level, the control unit 101 ends this flow and then executes the processing at step S505 in FIG. 5. That is, the control unit 101 does not perform the LiDAR distance measurement but controls the first optical system to acquire the first distance information. To which of the steps the flow proceeds in a case where the remaining battery level is equal to the predetermined level may be arbitrarily set. In this embodiment, the processing at step S901 is performed before the LiDAR distance measurement but, for example, the processing at step S901 may be performed before or during the processing in FIG. 5.

As described above, the configuration according to this embodiment can reduce electric power consumption.

### Fourth Embodiment

This embodiment will discuss an example that detects a light amount of environmental light and does not perform the LiDAR distance measurement in a case where the detected environmental light amount is smaller than a predetermined light amount value. This embodiment will discuss a configuration different from that of the first to third embodiments, and will omit a description of a common configuration.

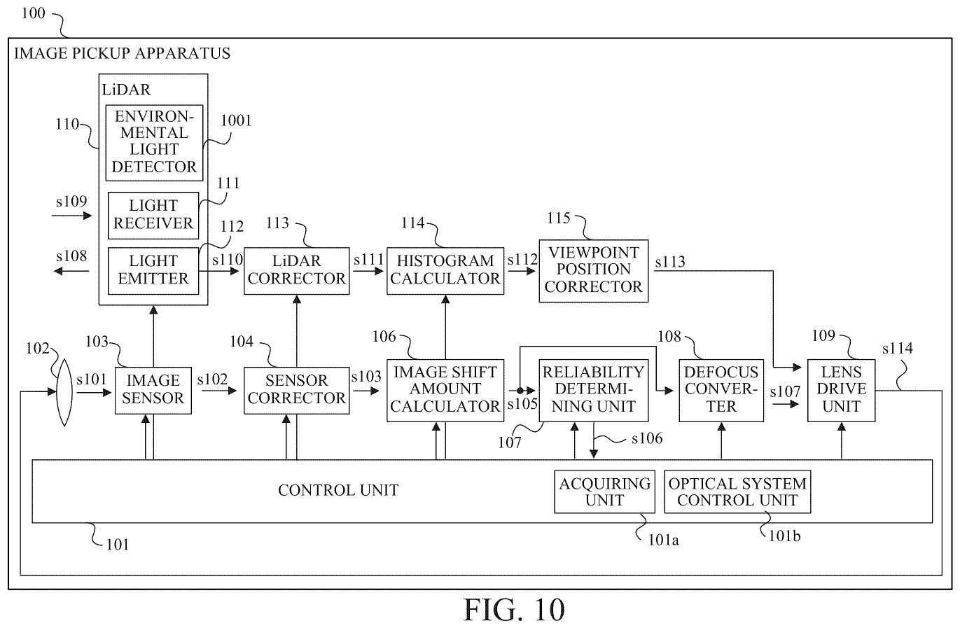

FIG. 10 is a block diagram of the configuration of the image pickup apparatus 100 according to this embodiment. The configuration of the image pickup apparatus 100 according to this embodiment is basically the same as that of the image pickup apparatus 100 according to the first embodiment. In this embodiment, the LiDAR distance measuring unit 110 includes an environmental light detector 1001 unlike the first embodiment. The environmental light detector 1001 detects the environmental light amount. The environmental light is light other than an infrared laser beam emitted by the laser light emitter 112. An unillustrated IR filter through which only infrared light passes is installed in the laser light receiver 111, but in a case where the environmental light amount is large, visible light or the like other than infrared light leaks into the photoelectric converters and causes noise. Thereby, it becomes difficult to perform highly accurate distance measurement. Furthermore, in a case where a plurality of LiDAR-mounted devices exist in surroundings, an infrared laser beam from any other device may wrongly enter the image pickup apparatus 100. It is thus difficult to obtain highly accurate distance information by driving the LiDAR distance measuring unit 110 in a case where the environmental light amount is large whether or not the light is visible or invisible.

Accordingly, in this embodiment, the control unit 101 does not drive the LiDAR distance measuring unit 110 but acquires distance information using the first optical system in a case where the environmental light amount, which is detected by the environmental light detector 1001 is larger than a predetermined amount. This configuration can reduce electric power consumption while suppressing a decrease of the distance measuring accuracy.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD) TM), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each embodiment can provide a control apparatus capable of highly accurately acquiring distance information with reduced electric power consumption.

This application claims priority to Japanese Patent Application No. 2023-096150, which was filed on Jun. 12, 2023, and which is hereby incorporated by reference herein in its entirety.

What is claimed is:

1. A control apparatus configured to control a first optical system for acquiring image information and a second optical system different from the first optical system, the control apparatus comprising:
a memory storing instructions; and
a processor that executes the instructions to:
acquire at least one of first distance information corresponding to the image information and obtained by using the first optical system, and second distance information corresponding to the image information and obtained by using the second optical system, and
control the first optical system to acquire the first distance information in a case where reliability of the first distance information is higher than a predetermined value, and control the second optical system to acquire the second distance information in a case where the reliability is lower than the predetermined value.

2. The control apparatus according to claim 1, wherein the reliability is higher than the predetermined value in a case where contrast of the image information is higher than a predetermined contrast value, and the reliability is lower than the predetermined value in a case where the contrast is lower than the predetermined contrast value.

3. The control apparatus according to claim 1, wherein the reliability is higher than the predetermined value in a case where a focus position of the first optical system is in a predetermined range, and the reliability is lower than the predetermined value in a case where the focus position is outside the predetermined range.

4. The control apparatus according to claim 1, wherein the processor is configured to control the second optical system to acquire the second distance information in a case where the reliability is higher than the predetermined value and an image for recording is acquired by using the first optical system.

5. The control apparatus according to claim 1, wherein a frame rate of acquiring the second distance information is lower than a frame rate of acquiring of the first distance information.

6. The control apparatus according to claim 1, wherein the processor is configured to control the first optical system to acquire the first distance information in a case where the reliability is lower than the predetermined value and a remaining battery level for driving the first optical system and the second optical system is smaller than a predetermined level.

7. The control apparatus according to claim 1, wherein the processor is configured to control the first optical system to acquire the first distance information in a case where the reliability is lower than the predetermined value and a light amount of environmental light different from light that has been emitted from the second optical system and then reflected by a target is larger than a predetermined amount.

8. The control apparatus according to claim 1, wherein the processor is configured to acquire the first distance information based on outputs from phase difference detecting pixels configured to detect a phase difference between images.

9. The control apparatus according to claim 1, wherein the processor is configured to acquire the second distance information using a light emitter configured to emit light and a light receiver configured to receive the light reflected by a target.

10. An image pickup apparatus comprising:
the control apparatus according to claim 1;
the first optical system; and
the second optical system.

11. A control method configured to control a first optical system for acquiring image information and a second optical system different from the first optical system, the control method comprising the steps of:
acquiring at least one of first distance information corresponding to the image information and obtained by using the first optical system, and second distance information corresponding to the image information and obtained by using the second optical system, and
controlling the first optical system to acquire the first distance information in a case where reliability of the first distance information is higher than a predetermined value, and control the second optical system to acquire the second distance information in a case where the reliability is lower than the predetermined value.

12. A non-transitory computer-readable storage medium storing a computer program that causes a computer to execute the control method according to claim 11.
